(19) United States
(12) Patent Application Publication
(10) Pub. No.: US 2026/0345305 A1
(43) Pub. Date: Nov. 5, 2026

(54) ELECTRIC TOOTHBRUSH

(71) Applicant: NINGBO SEAGO ELECTRIC CO., LTD., Ningbo City (CN)

(72) Inventors: Weibing Peng, Ningbo City (CN); Yanzhong Cai, Ningbo City (CN); Huiming Liu, Ningbo City (CN); Yuli Wang, Ningbo City (CN)

(21) Appl. No.: 19/295,759

(22) Filed: Aug. 11, 2025

(30) Foreign Application Priority Data
Apr. 30, 2025 (CN) 202510570622.6

(51) Int. Cl. A61C 17/34; A46B 5/00; A46B 13/02; A61C 17/22

(52) U.S. Cl. CPC A61C 17/3472; A46B 5/00; A46B 13/023; A61C 17/221; A61C 17/225; A61C 17/3454; A61C 17/3463

(57) ABSTRACT

The present disclosure provides an electric toothbrush, which comprises a toothbrush handle and a toothbrush head, wherein the toothbrush handle comprises a drive shaft to which the toothbrush head is fixed and mounted, and a motor; the motor can drive the drive shaft to perform a first movement and a second movement; in a state where the toothbrush head is mounted to the drive shaft in a first mounting mode, the toothbrush head performs the first movement at an amplitude larger than an amplitude at which the second movement is performed; and in a state where the toothbrush head is mounted to the drive shaft in a second mounting mode, the toothbrush head performs the second movement at an amplitude larger than an amplitude at which the first movement is performed.

### CROSS-REFERENCE TO RELATED APPLICATIONS

The present disclosure claims the priority to the Chinese patent application No. 202510570622.6 filed with the Chinese Patent Office on Apr. 30, 2025, and entitled “ELECTRIC TOOTHBRUSH”, the contents of which are incorporated herein by reference in entirety.

### TECHNICAL FIELD

The present disclosure relates to the technology field of oral hygiene and in particular to an electric toothbrush.

### BACKGROUND ART

An electric toothbrush produces high-frequency vibration in a toothbrush head by rapid rotation or vibration of an electric core, by which toothpaste is instantaneously decomposed into fine foam and deeply cleans crevices between teeth. Meanwhile, the fluttering of bristles can facilitate blood circulation in the mouth and has the effect of massaging gum tissue.

In the prior art, an eccentric block is rotationally driven by a motor to produce vibration, however, such structure has deficiencies in vibration frequency, vibration amplitude, and force transmission, and the vibration outputted to the toothbrush head is greatly attenuated, resulting in low vibration efficiency, low vibration amplitude, and an indifferent cleaning effect.

### SUMMARY

In order to overcome or alleviate the above-mentioned problems existing in the prior art, the present disclosure aims to provide an electric toothbrush which has a better cleaning effect.

The present disclosure provides an electric toothbrush, comprising a toothbrush handle and a toothbrush head, wherein the toothbrush handle comprises a drive shaft to which the toothbrush head is fixed and mounted, and a motor;

the motor can drive the drive shaft to perform a first movement and a second movement;

in a state where the toothbrush head is mounted to the drive shaft in a first mounting mode, the toothbrush head performs the first movement at an amplitude larger than an amplitude at which the second movement is performed; and

in a state where the toothbrush head is mounted to the drive shaft in a second mounting mode, the toothbrush head performs the second movement at an amplitude larger than an amplitude at which the first movement is performed.

In at least one possible embodiment, the first movement is a tapping movement along a direction in which bristles of the toothbrush head extend, and the second movement is a swinging movement perpendicular to the direction in which the bristles of the toothbrush head extend.

In at least one possible embodiment, in the state where the toothbrush head is mounted to the drive shaft in the first mounting mode, when the toothbrush head is detached and rotated by 90 degrees about an axis of the drive shaft and then mounted, the toothbrush head can be switched to the second mounting mode.

In at least one possible embodiment, the drive shaft comprises a base and a positioning part, the positioning part is connected to an upper end of the base, the base can have a cylindrical shape or a conical shape, and the positioning part can have a columnar shape with a square, cross-shaped, or right-angle sectorial cross section;

the toothbrush head is provided with a drive shaft receiving hole, the drive shaft receiving hole is a stepped hole, the drive shaft receiving hole comprises a fitting hole and a positioning hole, the positioning hole is positioned at the bottom of the fitting hole, the fitting hole is a round hole, and the positioning hole is a square hole, a cross-shaped hole, or a semicircular hole; and

in the state where the toothbrush head is mounted to the drive shaft, the base is interference-fitted into the fitting hole, and the positioning part is inserted into the positioning hole.

In at least one possible embodiment, the toothbrush handle comprises:
a support frame provided with a hollow part;
a drive frame, wherein the drive frame comprises a frame body and the drive shaft extending from the frame body to an upper side of the electric toothbrush, the drive frame is elastically connected to the support frame through elastic parts, the frame body is positioned in the hollow part, the frame body is spaced apart from the support frame in most of its area, and the drive shaft is configured to be connected to a toothbrush head; and
the motor arranged on the frame body, wherein the motor is operable to drive the drive frame to move relative to the support frame along a frontward/rearward direction and a leftward/rightward direction of the electric toothbrush, so that the drive shaft can drive the toothbrush head to move along the frontward/rearward direction and the leftward/rightward direction, wherein
a dimension of the elastic part along the frontward/rearward direction of the electric toothbrush is smaller than a dimension of the elastic part along the leftward/rightward direction of the electric toothbrush, so that the drive shaft moves along the frontward/rearward direction at an amplitude larger than an amplitude at which the drive shaft moves along the leftward/rightward direction.

In at least one possible embodiment, the drive frame is connected to the support frame through a connecting part and the elastic part, the connecting part is connected around the drive shaft, and in an upward/downward direction of the electric toothbrush, the connecting part is spaced apart from the frame body in the upward/downward direction of the electric toothbrush.

In at least one possible embodiment, lower ends of the elastic parts are connected to the connecting part, and upper ends of the elastic parts are connected to the support frame, so that the elastic parts and the connecting part form a U shape; and the drive shaft and the connecting part are integrally connected by an injection molding process.

In at least one possible embodiment, the elastic parts are in the shape of sheets extending along the leftward/rightward direction and the upward/downward direction of the electric toothbrush, and a dimension of one connecting part along the leftward/rightward direction of the electric toothbrush is identical with a dimension of one elastic part along the leftward/rightward direction of the electric toothbrush.

In at least one possible embodiment, the electric toothbrush further comprises a circuit board, and the circuit board is positioned on a front side of the support frame in the frontward/rearward direction.

In at least one possible embodiment, an upper end of the support frame is provided with elastic part connecting parts, the elastic part connecting parts are positioned on both sides of the electric toothbrush in the frontward/rearward direction, the elastic parts are connected to the support frame through the elastic part connecting parts, and the elastic parts are spaced apart from the support frame in the frontward/rearward direction; and

in an upward/downward direction of the electric toothbrush, the drive shaft extends beyond uppermost ends of the elastic parts.

According to the above-mentioned technical solutions, the mode of mounting of the toothbrush head is changed so that an amplitude of a first movement of the toothbrush head is larger than an amplitude of a second movement thereof or the amplitude of the second movement is larger than the amplitude of the first movement, and a suitable movement mode can be switched according to actual requirements to improve the toothbrushing experience of a user.

### BRIEF DESCRIPTION OF DRAWINGS

FIG. 1 shows an exploded view of a partial structure of an electric toothbrush according to an embodiment of the present disclosure.

FIG. 2 shows a schematic structural diagram of a partial structure of an electric toothbrush according to an embodiment of the present disclosure.

FIG. 3 shows a side view of an electric toothbrush according to an embodiment of the present disclosure.

FIG. 4 shows a front view of an electric toothbrush according to an embodiment of the present disclosure.

FIG. 5 shows a rear view of an electric toothbrush according to an embodiment of the present disclosure.

FIG. 6 shows a schematic structural diagram of a support frame and a drive frame of an electric toothbrush according to an embodiment of the present disclosure.

FIG. 7 shows a partial enlarged view of an internal structure of an electric toothbrush according to an embodiment of the present disclosure.

FIG. 8 shows a front view of a drive shaft of an electric toothbrush according to one embodiment of the present disclosure.

FIG. 9 shows a top view of an electric toothbrush according to one embodiment of the present disclosure.

FIG. 10 shows a front view of a drive shaft of an electric toothbrush according to another embodiment of the present disclosure.

FIG. 11 shows a top view of an electric toothbrush according to another embodiment of the present disclosure.

FIG. 12 shows a front view of a drive shaft of an electric toothbrush according to yet another embodiment of the present disclosure.

FIG. 13 shows a left view of a drive shaft of an electric toothbrush according to yet another embodiment of the present disclosure.

FIG. 14 shows a top view of an electric toothbrush according to yet another embodiment of the present disclosure.

### Description of the Reference Numerals

100 toothbrush head
1 support frame;
11 hollow part;
12 battery accommodating groove;
13 elastic part connecting part;
2 drive frame;
21 drive shaft;
211 base;
212 positioning part;
22 motor groove;
23 counterweight groove;
24 elastic part;
25 connecting part;
26 frame body;
3 counterweight;
4 motor;
41 eccentric block;
5 shock absorber;
6 battery;
7 circuit board;
8 sealing ring;
9 waterproof ring;
A upward/downward direction; F frontward/rearward direction; R leftward/rightward direction.

### DETAILED DESCRIPTION OF EMBODIMENTS

In order to more clearly elaborate the above objectives, features, and advantages of the present disclosure, specific embodiments of the present disclosure are described in detail herein with reference to the drawings. The present disclosure can be implemented in other different ways in addition to the various embodiments described herein, and those skilled in the art can make corresponding improvements, variations, and replacements without departing from the spirit of the present disclosure, hence the present disclosure is not limited by the specific embodiments disclosed herein. The scope of protection of present disclosure shall be defined by the claims.

In the following description, an upward/downward direction A of an electric toothbrush represents a direction in which an axis of the electric toothbrush extends, where the upper side represents a side at which a toothbrush head 100 is located, and the lower side represents a side at which a toothbrush handle is located. A front side of a frontward/rearward direction F of the electric toothbrush is a side where a switch button of the electric toothbrush is located. A leftward/rightward direction R of the electric toothbrush is perpendicular to both the upward/downward direction A and the frontward/rearward direction F of the electric toothbrush.

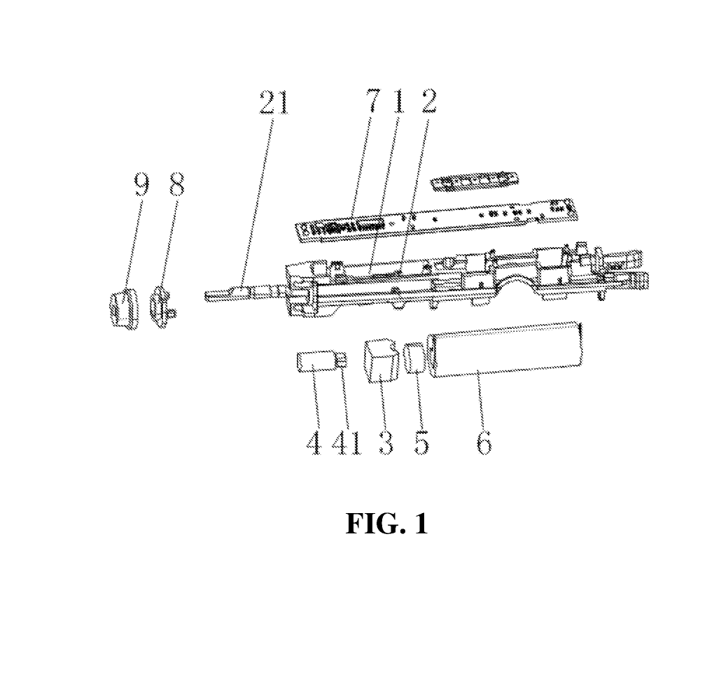

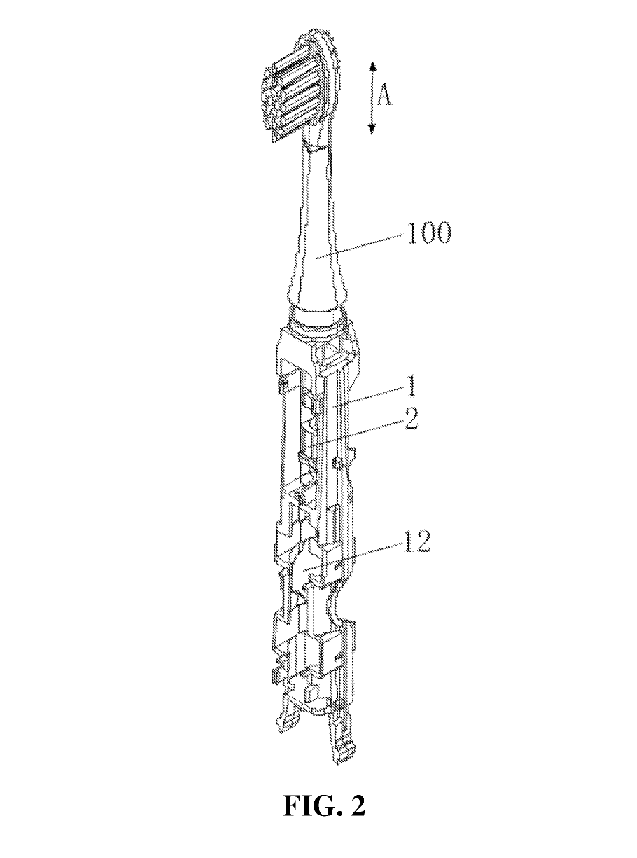

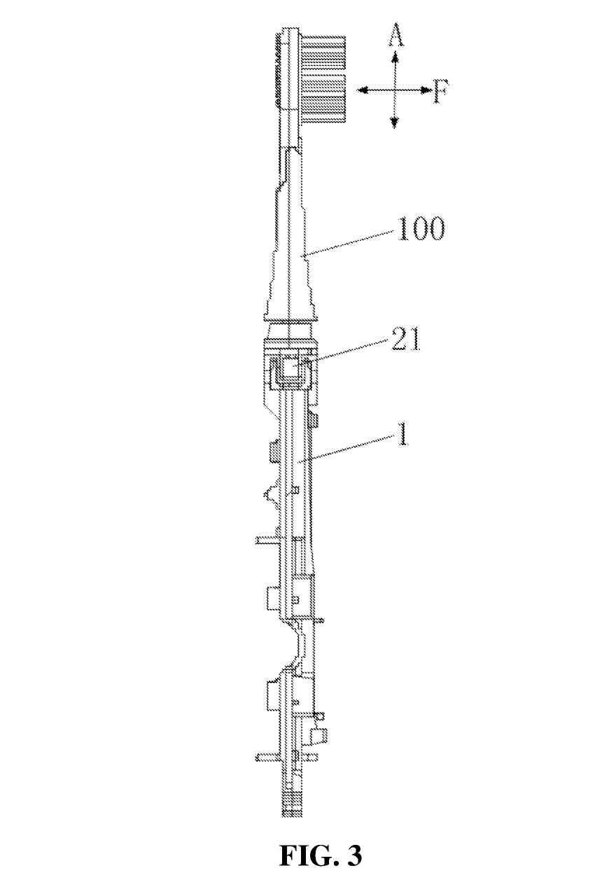

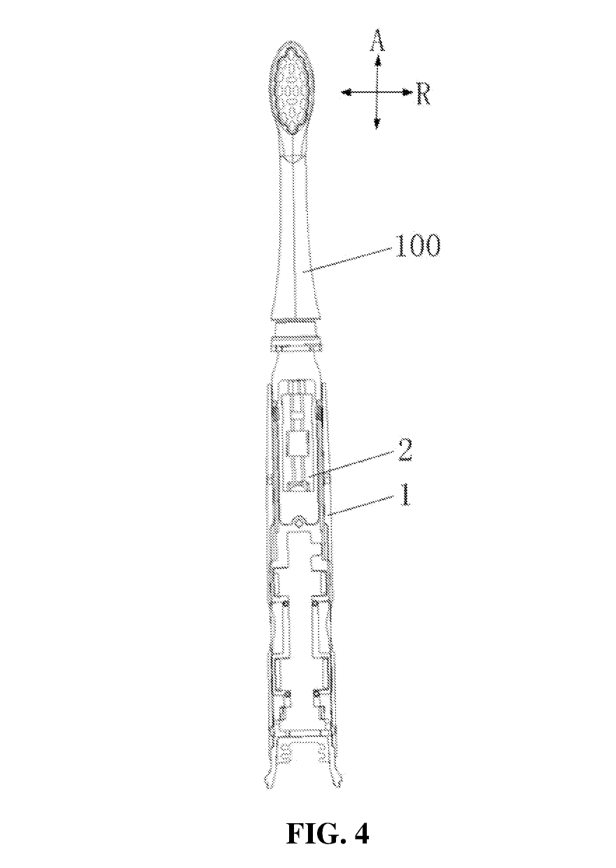

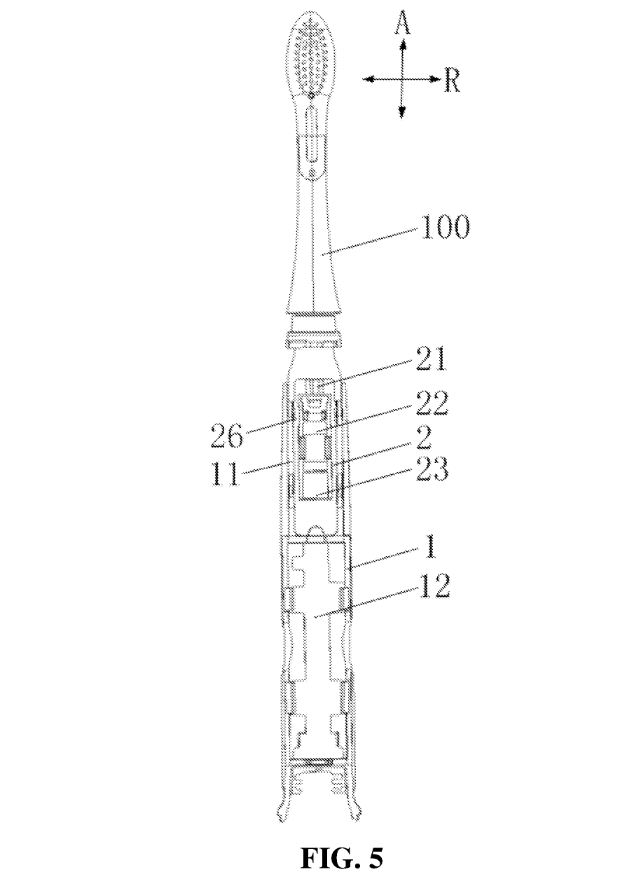

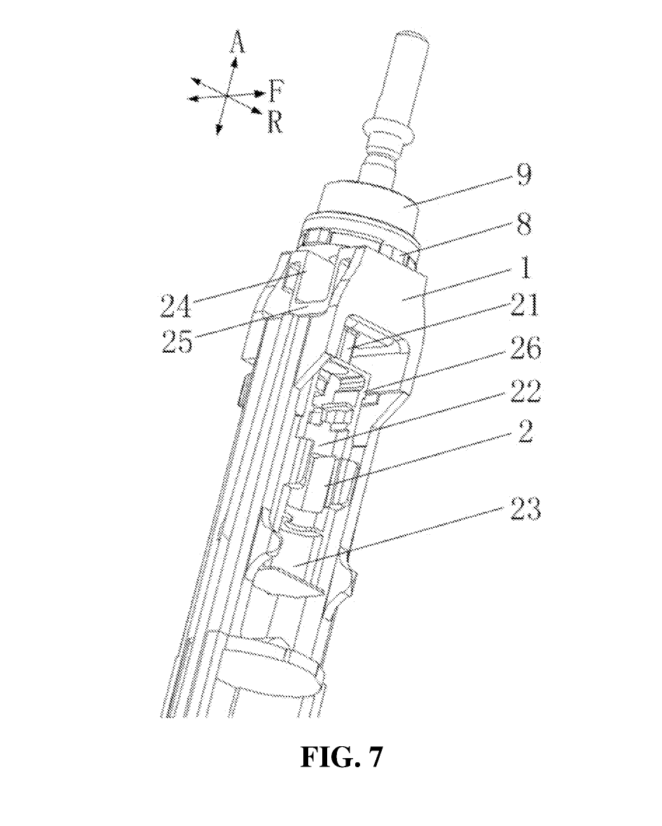

As shown in FIG. 1 to FIG. 7, an embodiment of the present disclosure provides an electric toothbrush comprising a toothbrush handle and a toothbrush head 100, where the toothbrush head 100 is mounted to an upper end of the toothbrush handle in a replaceable manner.

The toothbrush handle comprises a housing (not shown), a support frame 1, a drive frame 2, a counterweight 3, a motor 4, a shock absorber 5, a battery 6, a circuit board 7, a sealing ring 8, and a waterproof ring 9.

The support frame 1, the drive frame 2, the counterweight 3, the motor 4, the shock absorber 5, the battery 6, the circuit board 7, and the sealing ring 8 can be arranged inside the housing. An upper end of the housing has an opening, and the battery 6 and the circuit board 7 can be fixedly connected to the support frame 1. For example, the support frame 1 can be provided with a battery accommodating groove 12, and the battery 6 is mounted in the battery accommodating groove 12.

The circuit board 7 can be mounted to the front side of the support frame 1 in the frontward/rearward direction F, whereby a button can be arranged on the front side of the housing. The button can trigger a key (including a press key and a touch key) on the circuit board 7 to facilitate use by an operator.

The counterweight 3, the motor 4, and the shock absorber 5 can be mounted to the drive frame 2, and the drive frame 2 can be elastically connected to the support frame 1 through elastic parts 24. Vibration produced during operation of the motor 4 can drive the frame body 26 to perform a movement along the frontward/rearward direction F and a movement along the leftward/rightward direction R relative to the support frame 1, and then transmit the movements to a drive shaft 21 so that the drive shaft 21 drives the toothbrush head 100 to perform a movement along the frontward/rearward direction F and a movement along the leftward/rightward direction R.

The support frame 1 can be provided with a hollow part 11, the hollow part 11 can be positioned at an upper portion of the toothbrush handle in the upward/downward direction A, the hollow part 11 can extend through the support frame 1 along the frontward/rearward direction F, and the hollow part 11 can be positioned at the middle position of the electric toothbrush in the leftward/rightward direction R.

The drive frame 2 can comprise a frame body 26 and a drive shaft 21 extending from the frame body 26 to the upper side of the electric toothbrush in the upward/downward direction A, the drive shaft 21 is configured to be connected to the toothbrush head, and the toothbrush head 100 is detachably connected to the drive shaft 21 in a replaceable manner. The drive shaft 21 can have a columnar shape, and the drive shaft 21 can include a metal material and a plastic material. The metal material has good rigidity.

The frame body 26 can comprise a motor groove 22, and the motor 4 can be accommodated in the motor groove 22. In the upward/downward direction A of the electric toothbrush, the drive shaft 21 can be positioned on an upper side of the motor groove 22. An eccentric block 41 can be mounted to an output shaft of the motor 4 so that vibration can be produced when the motor 4 is rotating. In the upward/downward direction A of the electric toothbrush, the eccentric block 41 can be positioned on a lower side of the motor 4.

The drive frame 2 can be elastically connected to the support frame 1 through the elastic parts 24. For example, the frame body 26 can be elastically connected to the support frame 1 through the drive shaft 21, a connecting part 25, and the elastic part 24. The frame body 26 can be positioned in the hollow part 11, and the frame body 26 is spaced apart from the support frame 1 in most of its area. For example, the frame body 26 is spaced apart from the support frame 1 in at least the leftward/rightward direction R of the electric toothbrush, so that the frame body 26 is movable relative to the support frame 1. With the drive frame 2 and the support frame 1 elastically connected and spaced apart from each other as a whole, the toothbrush head 100 connected to the drive shaft 21 can have a certain degree of freedom of movement, so that the toothbrush head 100 can be subjected to forces in different directions, thereby cleaning teeth and massaging gums in a better way.

Further, the elastic parts 24 are in the shape of sheets extending along the leftward/rightward direction R and the upward/downward direction A as a whole. A dimension of one elastic part 24 along the frontward/rearward direction F of the electric toothbrush is smaller than a dimension of one elastic part 24 along the leftward and rightward direction R of the electric toothbrush. Therefore, when the motor 4 drives the drive frame 2 to move, the drive frame 2 can easily move relative to the support frame 1 along the frontward/rearward direction F, and then drive the toothbrush head 100 to move along the frontward/rearward direction F. The drive shaft 21 moves along the frontward/rearward direction F at an amplitude larger than an amplitude at which the drive shaft 21 swings along the leftward/rightward direction R.

It can be understood that the drive shaft 21 has a larger movement amplitude only in the frontward/rearward direction F, and in fact, the drive shaft 21 can be moved in multiple directions by being driven by the motor 4. For example, when viewed along the upward/downward direction A of the electric toothbrush, the movement of the motor 4 driven by the drive shaft 21 can be an elliptical movement, where the major axis direction of the elliptical movement can be the frontward/rearward direction F, and the minor axis direction of the elliptical movement can be the leftward/rightward direction R. Such multi-directional movement not only enables the bristles of the toothbrush head 100 to cover different surfaces of teeth, but also can more effectively remove dirt and plaque from crevices between teeth.

Here, the dimension of the sheet-shaped elastic part refers to a solid dimension of a single elastic part 24 of the two elastic parts 24, excluding the spacing between the two elastic parts 24.

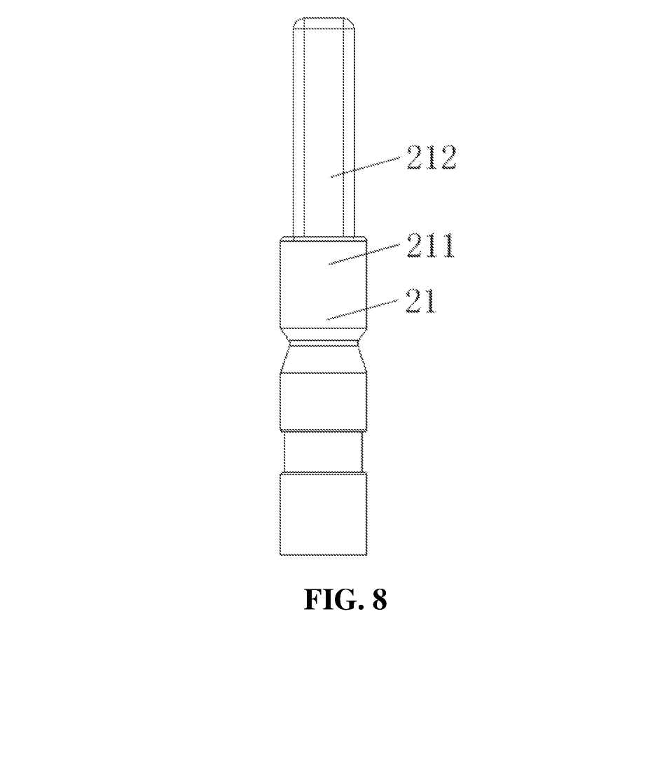

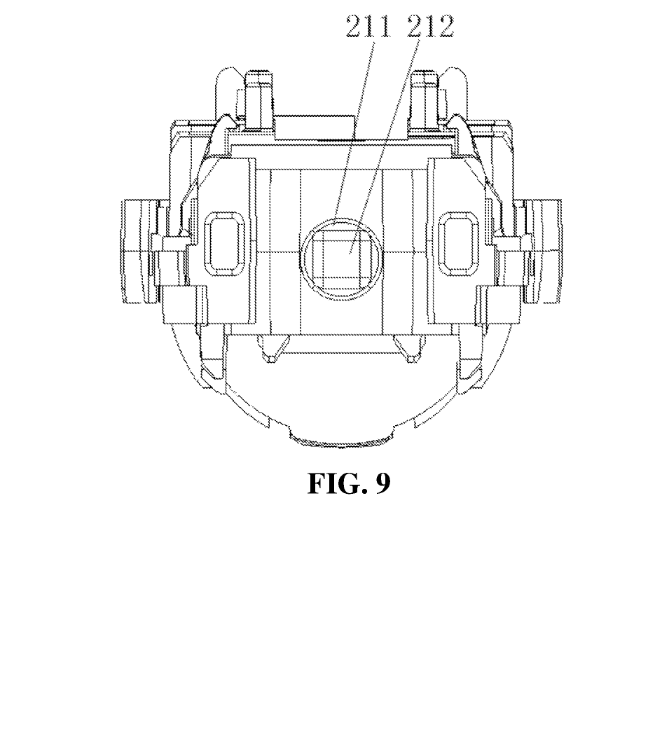

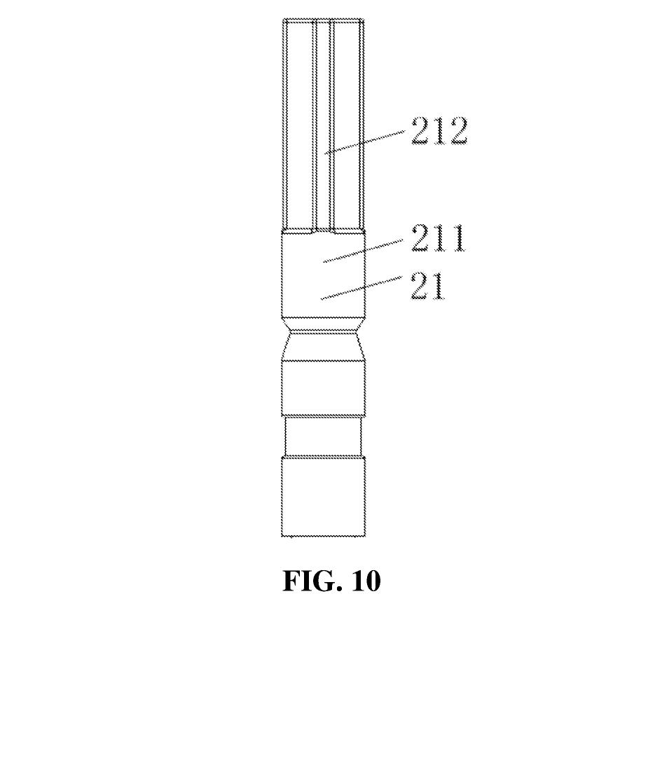

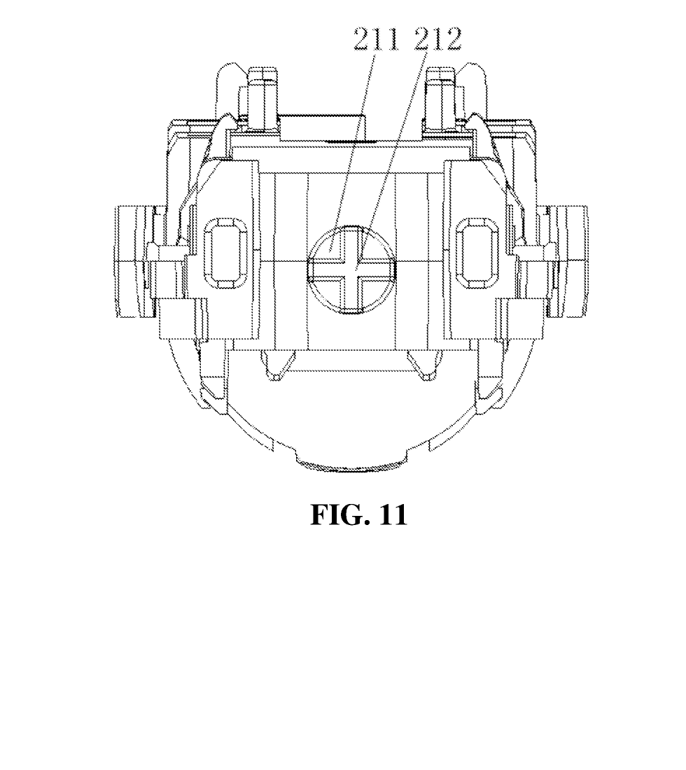

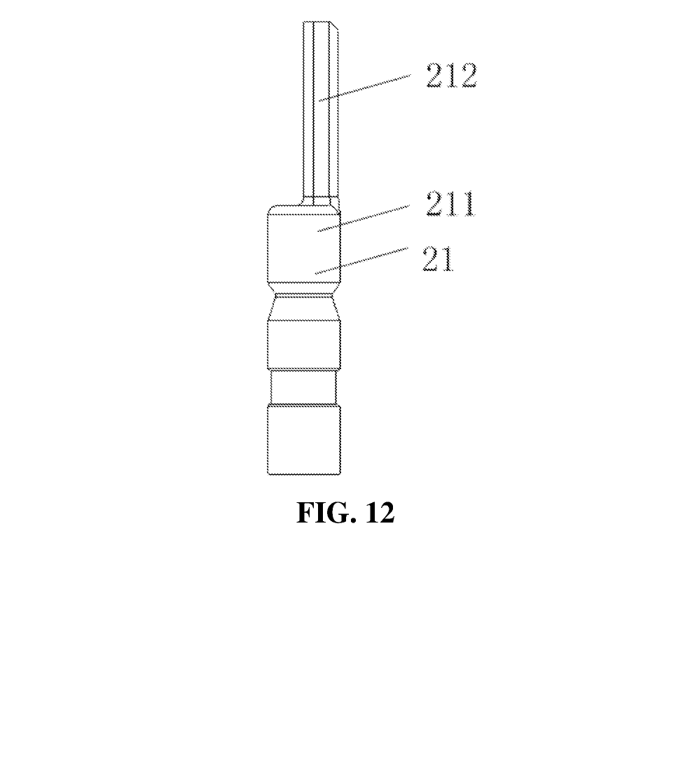

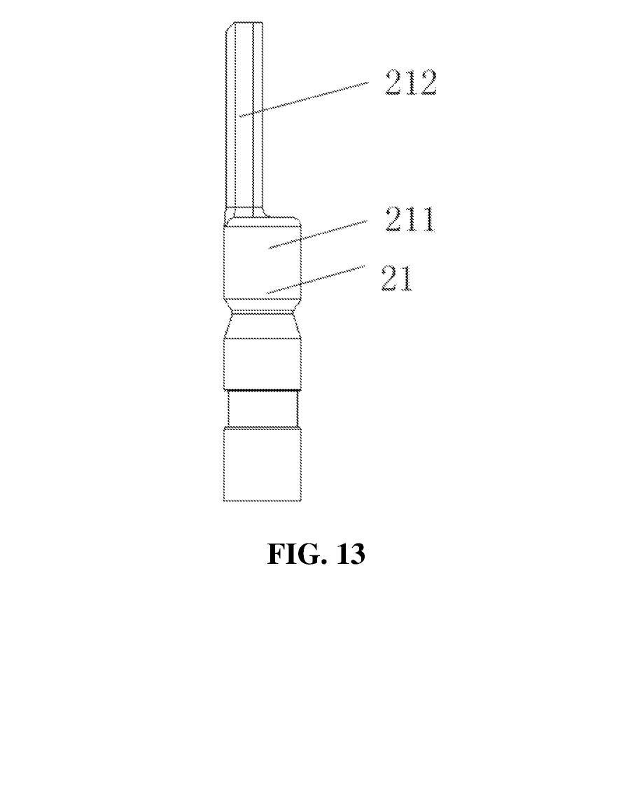

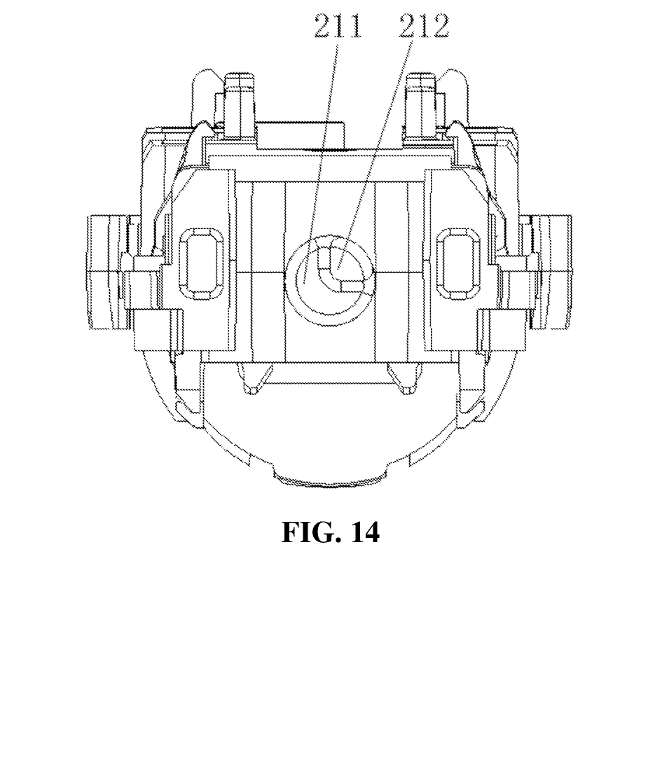

As shown in FIG. 8 to FIG. 14, the drive shaft 21 can comprise a base 211 and a positioning part 212, the base 211 can be connected to the frame body 26 of the drive frame 2, the positioning part 212 is connected to an upper end of the base 211, the base 211 can have a cylindrical shape (including a substantially cylindrical shape) or a conical shape (including a substantially conical shape), and the positioning part 212 can have a columnar shape with a square (referring to FIG. 8 and FIG. 9), cross-shaped (referring to FIG. 10 and FIG. 11), or right-angle sectorial (referring to FIGS. 12-14 ) cross section.

The toothbrush head 100 is provided with a drive shaft receiving hole. The drive shaft receiving hole is a stepped hole. The drive shaft receiving hole comprises a fitting hole and a positioning hole, where the positioning hole is positioned at the bottom of the fitting hole, the fitting hole can be a round hole, and the positioning hole can be a square hole, a cross-shaped hole, or a semicircular hole.

The toothbrush head 100 can be mounted to the drive shaft 21 in a first mounting mode or in a second mounting mode. In a state where the toothbrush head 100 is mounted to the drive shaft 21 (including the first mounting mode and the second mounting mode), the base 211 is interference-fitted into the fitting hole so that the toothbrush head 100 is fixedly connected to the drive shaft 21, and the positioning part 212 is inserted into the positioning hole to limit the direction of mounting of the toothbrush head 100.

In a state where the toothbrush head 100 is mounted to the drive shaft 21 in the first mounting mode, the bristles of the toothbrush head 100 can extend along the frontward/rearward direction F, where the front side is a side toward which the bristles are directed, and the rear side is a side from which the bristles face away. In the state where the toothbrush head 100 is mounted to the drive shaft 21 in the first mounting mode, when the toothbrush head 100 is detached and rotated by 90 degrees about the axis of the drive shaft 21 and then mounted, the toothbrush head 100 can be switched to the second mounting mode. In the state where the toothbrush head 100 is mounted to the drive shaft 21 in the second mounting mode, the bristles of the toothbrush head 100 can extend along the leftward/rightward direction R.

In the state where the toothbrush head 100 is mounted to the drive shaft 21 in the first mounting mode, the toothbrush head 100 performs a first movement at an amplitude larger than an amplitude at which a second movement is performed. The first movement is a tapping movement along a direction in which the bristles of the toothbrush head 100 extend, and the second movement is a swinging movement perpendicular to the direction in which the bristles of the toothbrush head 100 extend. In the first mounting mode which is suitable for deep cleaning, the bristles of the toothbrush head 100 can tap the teeth surfaces at a larger amplitude and swing in a direction perpendicular to the teeth surfaces at a smaller amplitude. In this way, a force exerted by the toothbrush head on the teeth surfaces can be increased, so that the electric toothbrush can more effectively clean the gap positions between teeth (crevices between teeth) and the gum line.

The back-and-forth tapping action of the toothbrush head 100 driven by the drive shaft 21 enables the toothbrush head 100 to fit the gum line well to massage the gums, facilitate blood circulation, and reduce the risk of gum bleeding while mildly irritating the gums to improve the toothbrushing experience of a user. The back-and-forth tapping action of the toothbrush head 100 enables the bristles to better enter the small crevices between the teeth that are difficult to reach, thereby improving the cleaning effect.

In the state where the toothbrush head 100 is mounted to the drive shaft 21 in the second mounting mode, the toothbrush head 100 performs the second movement at an amplitude larger than an amplitude at which the first movement is performed. In the second mounting mode which is suitable for rapid cleaning, the bristles of the toothbrush head 100 can swing at a larger amplitude to sweep over the teeth surfaces and tap the teeth surfaces at a smaller amplitude, so that the bristles can quickly sweep over a larger area of the teeth surfaces to brush the teeth quickly.

The frame body 26 can comprise a counterweight groove 23, and the counterweight 3 can be accommodated in the counterweight groove 23. Optionally, in the upward/downward direction A of the electric toothbrush, the counterweight groove 23 can be positioned on the lower side of the motor groove 22, and the counterweight 3 can be positioned on the lower side of the eccentric block 41. In the upward/downward direction A of the electric toothbrush, the drive shaft 21 can be positioned on the upper side of the motor groove 22, and the counterweight groove 23 can be positioned on the lower side of the motor groove 22. The counterweight 3 can increase the overall weight of the drive frame 2 to balance the vibration produced during operation of the motor and avoid imbalance caused by the vibration, so that the electric toothbrush can remain stable during use and that the toothbrush head can move more smoothly and efficiently.

The drive shaft 21 can be connected to the elastic parts 24 through the connecting part 25, the connecting part 25 can be sheet-shaped, and the connecting part 25 can surround the drive shaft 21. In the upward/downward direction A of the electric toothbrush, the connecting part 25 can be spaced apart from the frame body 26 by a distance. The connecting part 25 is connected to the support frame 1 through two elastic parts 24, and the elastic parts 24 can be positioned on the front and rear sides of the connecting part 25 in the frontward/rearward direction F.

When viewed along the leftward/rightward direction R of the electric toothbrush, the thickness of the connecting part 25 can be greater than the thickness of the elastic part 24. It can be understood that the thickness of the connecting part 25 can be adaptively changed according to design requirements. The elastic parts 24 enable the motor 4 to drive the frame body to move along an elliptical trajectory relative to the support frame 1. The elastic parts 24 can absorb and cushion externally applied forces (in particular an external force along the frontward/rearward direction F), such as vibration or shock during use, reduce damage to the overall structure, and thus improve the service life and grip comfort.

The elastic part 24 can have a rectangular cross section (section in a direction perpendicular to the upward/downward direction A), and a dimension of the connecting part 25 along the leftward/rightward direction R of the electric toothbrush can be identical (including substantial identicality) with a dimension of the elastic part 24 along the leftward/rightward direction R of the electric toothbrush. The lower ends of the elastic parts 24 can be connected to the connecting part 25, and the upper ends of the elastic parts 24 can be connected to the support frame 1, so that the elastic parts 24 and the connecting part 25 can form a U shape.

The upper end of the support frame 1 can be provided with an elastic part connecting part 13, two elastic part connecting parts 13 can be arranged, and the two elastic part connecting parts 13 can be positioned on the front and rear sides of the drive shaft 21 in the frontward/rearward direction F of the electric toothbrush. The elastic parts 24 can be connected to the support frame 1 through the elastic part connecting parts 13, and the elastic parts 24 are spaced apart from the support frame 1 in the frontward/rearward direction F.

The waterproof ring 9 can be mounted to the front end of the housing of the toothbrush handle, the waterproof ring 9 can cover the opening of the housing of the toothbrush handle, and the drive shaft 21 can pass through the waterproof ring 9.

The front end of the support frame 1 can be provided for example with two sealing ring mounting holes (not shown), and the two sealing ring mounting holes can be arranged in the elastic part connecting parts 13. The sealing ring 8 can be sleeved around the drive shaft 21, and fixing jaws of the sealing ring 8 can be mounted in the sealing ring mounting holes. The sealing ring 8 can prevent water or foam from entering the inside of the toothbrush handle, and the sealing ring 8 can reduce influence of vibration on the waterproof ring 9, thereby improving the sealing effect.

The drive shaft 21 can have a fulcrum thereon, and it can be understood that the fulcrum is an artificially defined virtual position, rather than a structurally existing support point. When the motor 4 drives the drive frame to move, the drive frame 2 can move around the fulcrum. It is understandable that the fulcrum can also be allowed to move within a certain range. For example, the vibration amplitude near the fulcrum can be controlled at 0.1 mm to 0.5 mm. In this way, vibration resistance in the area of the fulcrum can be reduced, so that vibration energy of the motor 4 can be more intensively transmitted to the elastic parts 24, thereby improving the vibration transmission efficiency. In the vicinity of the fulcrum, the vibration energy is concentrated, and an impact of excess vibration on the sealing ring 8 can be reduced by the vibration-absorbing effect of the elastic parts 24. At the position of the toothbrush head far away from the fulcrum, the vibration energy is released through the drive shaft 21, and the swing amplitude is amplified to enhance the cleaning effect.

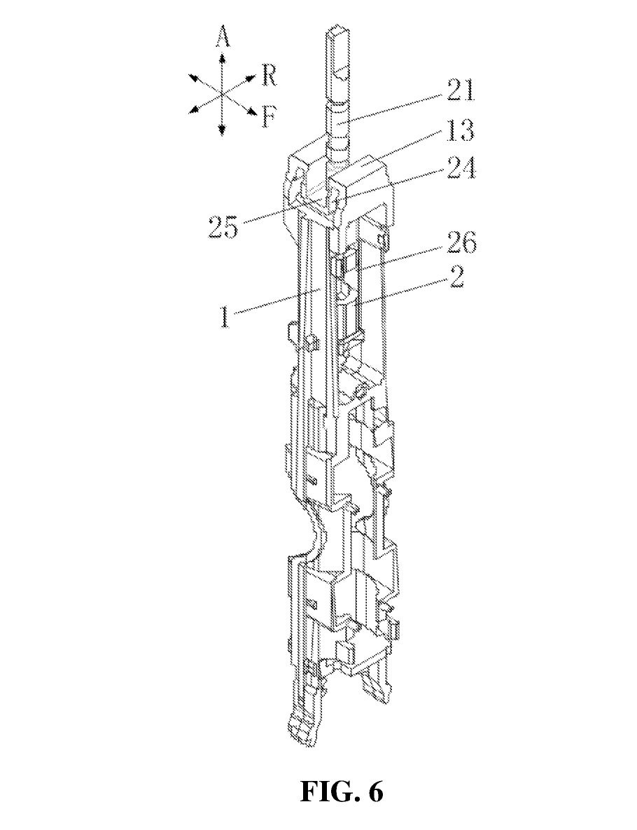

As shown in FIG. 6, the drive shaft 21 can extend beyond the uppermost end of the elastic part 24 in the upward/downward direction A. A longer drive shaft 21 enables the toothbrush head 100 to be farther away from the fulcrum, whereby the toothbrush head 100 can have a larger movement amplitude using the lever principle.

Optionally, in this embodiment, the elastic part 24, the connecting part 25, the frame body, and the support frame 1 can each be made of a plastic material, and the elastic part 24, the connecting part 25, the frame body, and the support frame 1 can be integrally molded. The drive shaft 21 is made of a metal, and the drive shaft 21 and the connecting part 25 can be connected integrally by an injection molding process. In this way, assembly and mounting errors and wear caused by contact fit can be reduced, so that the support frame 1 and the drive frame 2 can have higher overall structural strength and stability.

Optionally, the shock absorber 5 can be connected to the drive frame 2, at least a portion of the shock absorber 5 can be positioned in a gap between the drive frame 2 and the support frame 1, and the shock absorber 5 is elastic. For example, the shock absorber 5 can be foam or rubber. When the drive frame moves, the shock absorber 5 can effectively absorb and alleviate vibration transmitted to the support frame 1 to weaken the intensity of vibration transmitted to a user’s hand, thereby improving comfort of use. The motor 4 and other components can be protected by cushioning the vibration by the shock absorber 5, and noise generated during operation of the motor 4 can also be reduced, so that the electric toothbrush is quieter during use, and user experience is enhanced. In addition, the shock absorber 5 can also cushion external shocks, reduce damage caused by falls, and thus prolong the service life of the electric toothbrush.

In use of the electric toothbrush of the present disclosure, the electric toothbrush is turned on and powered on, so that the motor 4 starts rotating. The eccentric block 41 is rotationally driven by the motor 4, so that the frame body is moved about the fulcrum as an axis to transmit power to the drive shaft 21. The frame body and the toothbrush head are positioned at the two ends of the fulcrum, respectively, and the movement of the frame body is amplified at the positions of bristles of the toothbrush head by utilizing the lever principle. The toothbrush head mounted to the drive shaft 21 can have a movement amplitude of up to 3 to 5 millimeters, and thus has a better cleaning effect.

The electric toothbrush of the present disclosure has the following advantageous effects.
(1) The mode of mounting of the toothbrush head is changed so that an amplitude of a first movement of the toothbrush head is larger than an amplitude of a second movement thereof or the amplitude of the second movement is larger than the amplitude of the first movement, and a suitable movement mode can be switched according to actual requirements to improve the toothbrushing experience of a user.
(2) The drive frame 2 is driven by the motor 4 to move relative to the support frame 1, and thus the drive shaft 21 is driven to move the toothbrush head synchronously. Such design can effectively reduce vibration transmitted to the toothbrush handle, thereby reducing energy consumption and enhancing the toothbrushing effect. In addition, this structure is simple and can easily convert the rotary movement of the motor 4 into a movement of the drive shaft 21, so that its production cost is lower.
(3) The vibration is transmitted to the drive shaft 21 through the elastic parts 24, and thus a difference in vibration amplitude can be achieved in the vibration transmission path, where the vibration amplitude is smaller in the vicinity of the fulcrum so that the sealing ring 8 is not excessively pressed and deformed by the drive shaft 21 and can have a better sealing effect, and the vibration amplitude is larger at the upper end of the drive shaft 21 so that the toothbrush head has a higher cleaning efficiency.
(4) The drive shaft 21, the elastic parts 24, the connecting part 25, and the support frame 1 are integrally molded, so that the support frame 1 and the drive frame 2 have higher overall structural strength and better stability so as to avoid loosening of the connection and reduction of the vibration transmission efficiency caused by long-term vibration.
(5) The vibration of the drive frame 2 can be absorbed and cushioned by the elastic parts 24, so that less vibration is transmitted to the toothbrush handle and then to a user's hand. Therefore, the intensity of vibration transmitted to the user's hand is weakened, comfort of use is improved, and noise is reduced, so that the electric toothbrush is quieter during use, and the user experience is enhanced.
(6) The elastic parts 24 have a simple structure, and the integrally molded design is easily manufactured and assembled with a lower production cost.

It should be understood that at least some of the aspects or features of the above embodiments, implementations, or examples can be appropriately combined with each other.

It can be understood that, in the present disclosure, when the number of parts or components is not specifically limited, the number thereof can be one or multiple, where the term "multiple" refers to two or more. In the case where the number of parts or components shown in the drawings and/or described in the description is a specific quantity, such as two, three, or four, the specific quantity is usually exemplary and not restrictive and can be construed as multiple, i.e., two or more, however, this does not mean that the number “one” is excluded in the present disclosure.

In the present disclosure, unless otherwise expressly stated or defined, the terms "mount", "assemble", "assembling", "couple", "connect", "link", "attach", "abut", "communicate", “communicating”, "conduct”, "fix", "fasten", and the like should be construed in a broad sense, for example, directly or indirectly. For example, connection can be fixed connection, detachable connection, or integral connection, or can be mechanical connection or electrical connection, or can be direct connection or indirect connection through an intermediate medium, or internal communication between two elements or interaction between two elements, unless otherwise expressly stated or defined. For example, communication/conduction or the like can be direct communication/conduction, or indirect communication/conduction through an intermediate medium. It will be appreciated by those of ordinary skill in the art that the specific meanings of the above terms in the present disclosure can be understood according to specific situations.

In the present disclosure, unless otherwise expressly stated or defined, a component arranged /mounted/ positioned/ accommodated/ disposed in, within, or inside another component can be either of: the component partially or mostly positioned within the another component; and the component wholly accommodated within the another component.

Although the present disclosure is described in detail using the above embodiments, it is apparent to those skilled in the art that the present disclosure is not limited to the embodiments described in this specification. The present disclosure can be modified and implemented as a variant embodiment without departing from the spirit and scope of the present disclosure determined by the claims. Therefore, the description in this specification is for illustrative purposes only and is not intended to limit the present disclosure in any way.

What is Claimed is:

1. An electric toothbrush, comprising a toothbrush handle and a toothbrush head, wherein the toothbrush handle comprises a drive shaft to which the toothbrush head is fixed and mounted, and a motor;
the motor is able to drive the drive shaft to perform a first movement and a second movement;
in a state where the toothbrush head is mounted to the drive shaft in a first mounting mode, the toothbrush head performs the first movement at an amplitude larger than an amplitude at which the second movement is performed; and
in a state where the toothbrush head is mounted to the drive shaft in a second mounting mode, the toothbrush head performs the second movement at an amplitude larger than an amplitude at which the first movement is performed.

2. The electric toothbrush according to claim 1, wherein the first movement is a tapping movement along a direction in which bristles of the toothbrush head extend, and the second movement is a swinging movement perpendicular to the direction in which the bristles of the toothbrush head extend.

3. The electric toothbrush according to claim 1, wherein in the state where the toothbrush head is mounted to the drive shaft in the first mounting mode, when the toothbrush head is detached and rotated by 90 degrees about an axis of the drive shaft and then mounted, the toothbrush head is able to be switched to the second mounting mode.

4. The electric toothbrush according to claim 1, wherein the drive shaft comprises a base and a positioning part, the positioning part is connected to an upper end of the base, the base is capable of having a cylindrical shape or a conical shape, and the positioning part is capable of having a columnar shape with a square, cross-shaped, or right-angle sectorial cross section;
the toothbrush head is provided with a drive shaft receiving hole, the drive shaft receiving hole is a stepped hole, the drive shaft receiving hole comprises a fitting hole and a positioning hole, the positioning hole is positioned at the bottom of the fitting hole, the fitting hole is a round hole, and the positioning hole is a square hole, a cross-shaped hole, or a semicircular hole; and
in the state where the toothbrush head is mounted to the drive shaft, the base is interference-fitted into the fitting hole, and the positioning part is inserted into the positioning hole.

5. The electric toothbrush according to claim 1, wherein the toothbrush handle comprises:
a support frame provided with a hollow part;
a drive frame, wherein the drive frame comprises a frame body and the drive shaft extending from the frame body to an upper side of the electric toothbrush, the drive frame is elastically connected to the support frame through elastic parts, the frame body is positioned in the hollow part, the frame body is spaced apart from the support frame in most regions, and the drive shaft is configured to be connected to a toothbrush head; and
the motor arranged on the frame body, wherein the motor is able to drive the drive frame to move relative to the support frame along a frontward/rearward direction and a leftward/rightward direction of the electric toothbrush, so that the drive shaft is able to drive the toothbrush head to move along the frontward/rearward direction and the leftward/rightward direction, wherein
a dimension of one elastic part along the frontward/rearward direction of the electric toothbrush is smaller than a dimension of one elastic part along the leftward/rightward direction of the electric toothbrush, so that the drive shaft moves along the frontward/rearward direction at an amplitude larger than an amplitude at which the drive shaft moves along the leftward/rightward direction.

6. The electric toothbrush according to claim 5, wherein the drive frame is connected to the support frame through a connecting part and the elastic parts, the connecting part is connected around the drive shaft, and in an upward/downward direction of the electric toothbrush, the connecting part is spaced apart from the frame body in the upward/downward direction of the electric toothbrush.

7. The electric toothbrush according to claim 6, wherein lower ends of the elastic parts are connected to the connecting part, and upper ends of the elastic parts are connected to the support frame, so that the elastic parts and the connecting part form a U shape; and the drive shaft and the connecting part are integrally connected by an injection molding process.

8. The electric toothbrush according to claim 6, wherein the elastic parts are in the shape of a sheet extending along the leftward/rightward direction and the upward/downward direction of the electric toothbrush, and a dimension of the connecting part along the leftward/rightward direction of the electric toothbrush is identical with a dimension of one elastic part along the leftward/rightward direction of the electric toothbrush.

9. The electric toothbrush according to claim 5, wherein the electric toothbrush further comprises a circuit board, and the circuit board is positioned on a front side of the support frame in the frontward/rearward direction.

10. The electric toothbrush according to claim 5, wherein an upper end of the support frame is provided with elastic part connecting parts, the elastic part connecting parts are positioned on both sides of the electric toothbrush in the frontward/rearward direction, the elastic parts are connected to the support frame through the elastic part connecting parts, and the elastic parts are spaced apart from the support frame in the frontward/rearward direction; and
in an upward/downward direction of the electric toothbrush, the drive shaft extends beyond an uppermost end of each elastic part.
